(19) United States
(12) Patent Application Publication
(10) Pub. No.: US 2013/0268576 A1
(43) Pub. Date: Oct. 10, 2013

(54) METHOD AND APPARATUS FOR DATA TRANSFER RECONCILIATION

(71) Applicants: Richard Barnett, Irvington, NY (US); Arun Kumar, New York, NY (US)

(72) Inventors: Richard Barnett, Irvington, NY (US); Arun Kumar, New York, NY (US)

(21) Appl. No.: 13/440,779

(22) Filed: Apr. 5, 2012

(51) Int. Cl. H04L 29/08

(52) U.S. Cl. CPC H04L 29/08072
USPC 709/203

(57) ABSTRACT

A computer-implemented method and system for providing customized information from a content provider to a plurality of recipients. A content provider first ranks, via a content provider interface provided via a first computer server, a selected portion of the recipients into at least two separate tiers of recipients based upon a predetermined criteria. The content provider, generates, at the first computer server and via the content provider interface, customized information for transmission to the recipients. The content provider also generates, at the first computer server and via the content provider interface, associated information related to the customized information for each separate tier. Finally, the customized information and the respective associated information is transmitted to each tier of recipients. Preferably, the customized information comprises information identifying particular financial instruments offered for sale. In addition, the associated information comprises pricing information for the particular financial instruments offered for sale.

### FIELD OF INVENTION

This invention relates generally to a method and apparatus for providing customized information from a content provider to a plurality of recipients.

### BACKGROUND OF THE INVENTION

In the fast moving world of commerce such as the financial markets, there is a need to address the information overload problem. Consumers need to be able to easily select the content they wish to see and how they want to see it. The providers of content need to be able to ensure that they are correctly targeting the right audience to maximize the likelihood of generating business. Finance is one such example of this where, currently, participants in the financial markets resort to using traditional communication media like email, email-style systems and instant messaging to convey pricing information. These types of systems provide little transparency for the content providers, an inability to easily cater to different categories of clients, poor control for recipients of this information, often resulting in an overwhelming and inefficient experience.

For example, the institutional financial markets are broadly broken down into two distinct types of market players: (1) providers of financial data, content and opinion, much of which is proprietary (e.g., over-the-counter pricing); and (2) consumers of this content. Examples of the providers of this type of content include institutional financial firms such as banks, broker-dealers or inter-dealer brokers (i.e., the “sell side”). An example of this type of content includes over-the-counter pricing for instruments such as fixed income securities or structured products whose value is calculated by the providers (as opposed to something that is priced on an exchange which matches buyers and sellers). An example of the type of consumer for this information include investment management firms who manage funds for the purpose of increasing their value for the benefit of investors and companies managing their own funds such as insurance companies (i.e., the “buy side”). Consumers of this information can also include sell side participants such as sales people in banks who may re-distribute content provided by traders to their clients and inter-dealer brokers who match buyers and sellers.

Conventionally, providers use traditional communications mechanisms, as discussed above, and send content information to groups of consumers, either by way of large mailing list groups or custom mailing lists. Furthermore, it is not readily possible for consumers to easily tailor the types of content information to be received or viewed.

In view of the foregoing, it is desirable to provide a better method and apparatus for communicating information between providers and consumers.

### SUMMARY OF THE INVENTION

A computer-implemented method and system for providing customized information from a content provider to a plurality of recipients. A content provider first ranks, via a content provider interface provided via a first computer server, a selected portion of the recipients into at least two separate tiers (groupings) of recipients based upon a predetermined criteria. The content provider, generates, at the first computer server and via the content provider interface, customized information for transmission to the recipients. The content provider also generates, at the first computer server and via the content provider interface, associated information related to the customized information for each separate tier. Finally, the customized information and the respective associated information is transmitted to each tier of recipients.

Preferably, the customized information comprises information identifying particular financial instruments offered for sale. In addition, the associated information comprises pricing information for the particular financial instruments offered for sale. Further, the predetermined criteria may, in an embodiment, comprise a rating based upon past purchases by each customer. In one embodiment, the predetermined criteria comprises a credit rating of each customer. In an alternative embodiment, each customer provides information prior to receiving any customized information and wherein the ranking step is also based upon the information provided by each customer.

The computer-implemented method and system also allows the content provider to identify one or more particular recipients not included with any of the tiers of recipients to be associated with a respective one of the tiers of recipients, and for each identified one or more particular recipients, the customized information and the respective associated information for the associated one of the tiers of recipients is transmitted to the identified one or more particular recipients.

In an additional variation to the preferred embodiment, the computer-implemented method and system provides customized information from a plurality of content providers to a plurality of recipients. In this embodiment, each of the plurality of content providers first ranks, in a first computer server, a selected portion of the recipients associated with that content provider into at least two separate tiers of recipients based upon a predetermined criteria. Each content provider then generates, at the first computer server and via an associated content provider interface, customized information for transmission to the recipients and also generates associated information related to the customized information for each separate tier. Finally, the customized information and the respective associated information for each content provider is transmitted to each tier of associated recipients.

### BRIEF DESCRIPTION OF THE DRAWINGS

The following detailed description, given by way of example and not intended to limit the present invention solely thereto, will best be understood in conjunction with the accompanying drawings in which:

FIG. 1 is a block diagram of an exemplary system and associated workflow for carrying out a preferred embodiment of the present invention;

FIG. 2 is a block diagram of certain workflow aspects of a preferred embodiment of the present invention;

FIG. 3 is a block diagram of the system architecture of a preferred embodiment of the present invention;

FIG. 4 is a screen shot of the user navigation screen in a preferred embodiment of the present invention;

FIG. 5 is a screen shot of an example results page provided in response to user input in a preferred embodiment of the present invention;

FIG. 6 is a screen shot showing a provider management page in a preferred embodiment of the present invention;

FIG. 7 is a screen shot showing a tier management page for use by providers in a preferred embodiment of the present invention;

FIG. 8 is a screen shot showing a template composition page for use by providers in a preferred embodiment of the present invention;

FIG. 9 is a screen shot showing a tier management page for use by providers in a preferred embodiment of the present invention;

FIG. 10 is a screen shot showing a contact management page for use by providers in a preferred embodiment of the present invention;

FIGS. 11A, 11B and 11C show screen shots of view box settings pages and an associated filter setting screen in a preferred embodiment of the present invention; and

FIG. 12 is a screen shot of a user received message page in a preferred embodiment of the present invention.

### DETAILED DESCRIPTION OF THE PREFERRED EMBODIMENT

The present invention provides a method and apparatus for linking content providers and consumers by matching the interests of consumers of financial data and content (buy side) and the providers of such financial data and content (sell side). In the context of the present invention, a “user” refers to a member of the product target customer audience i.e., a user may refer to both recipients and providers, depending on the flow of content.

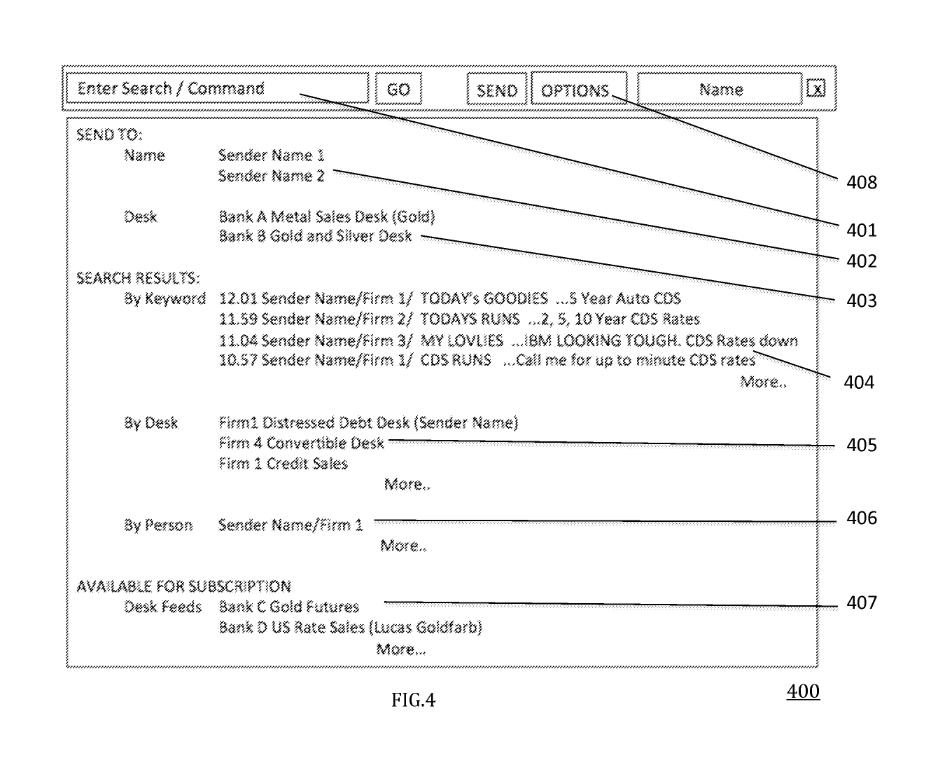

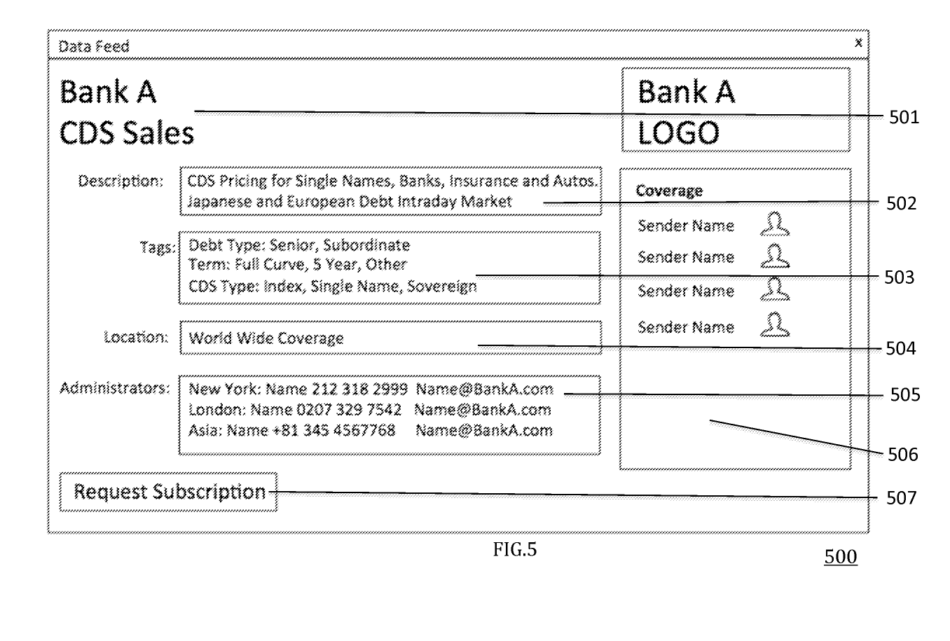

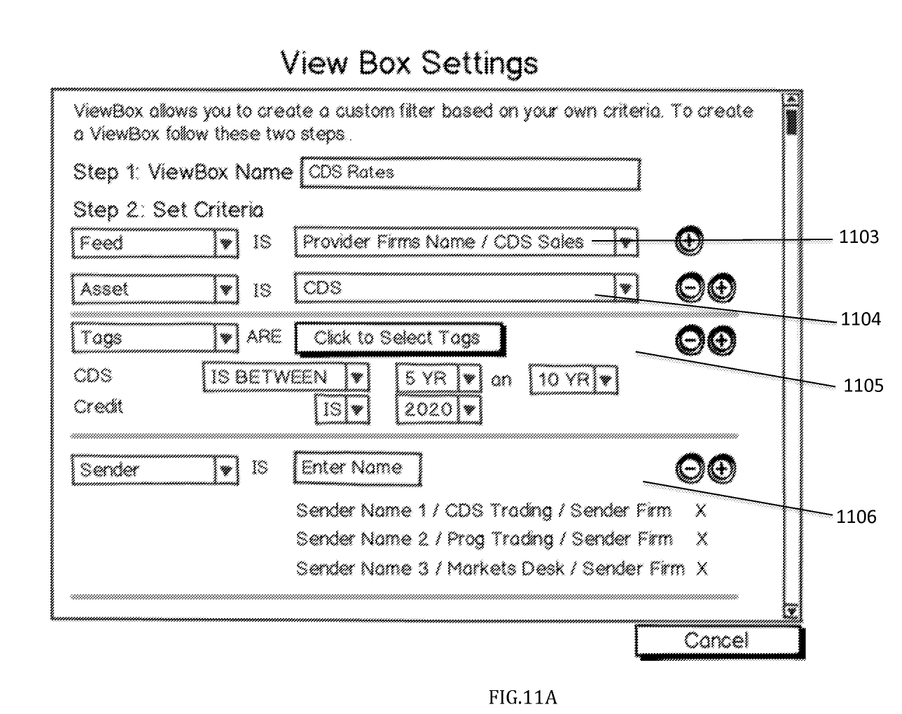

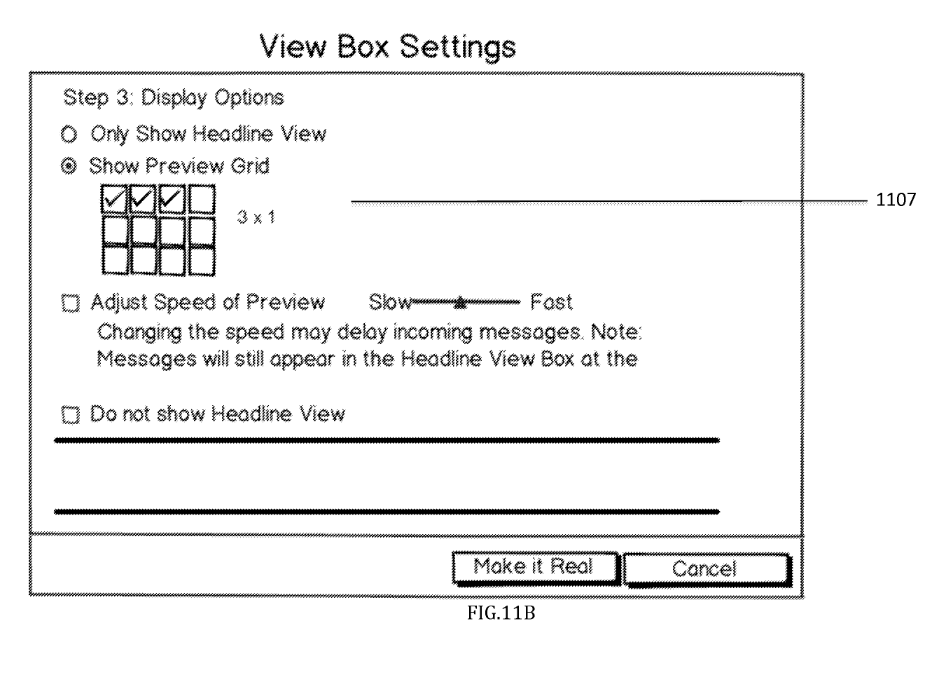

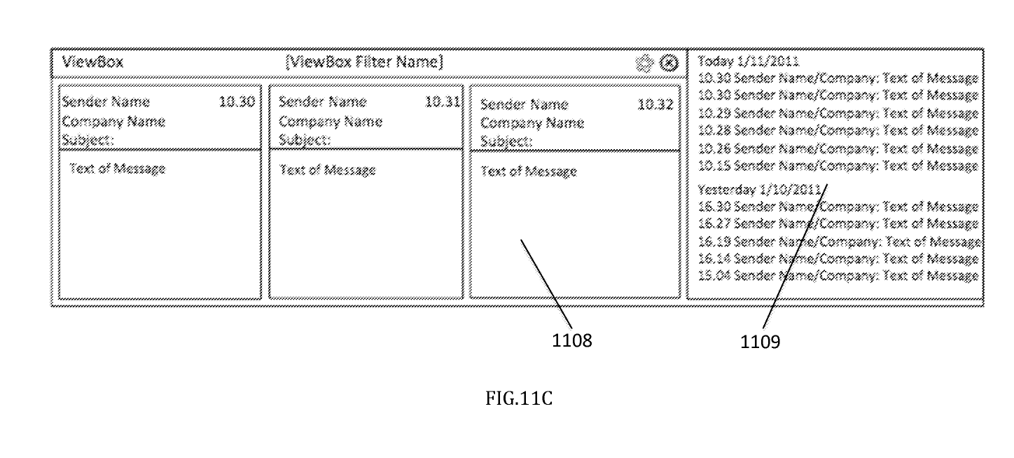

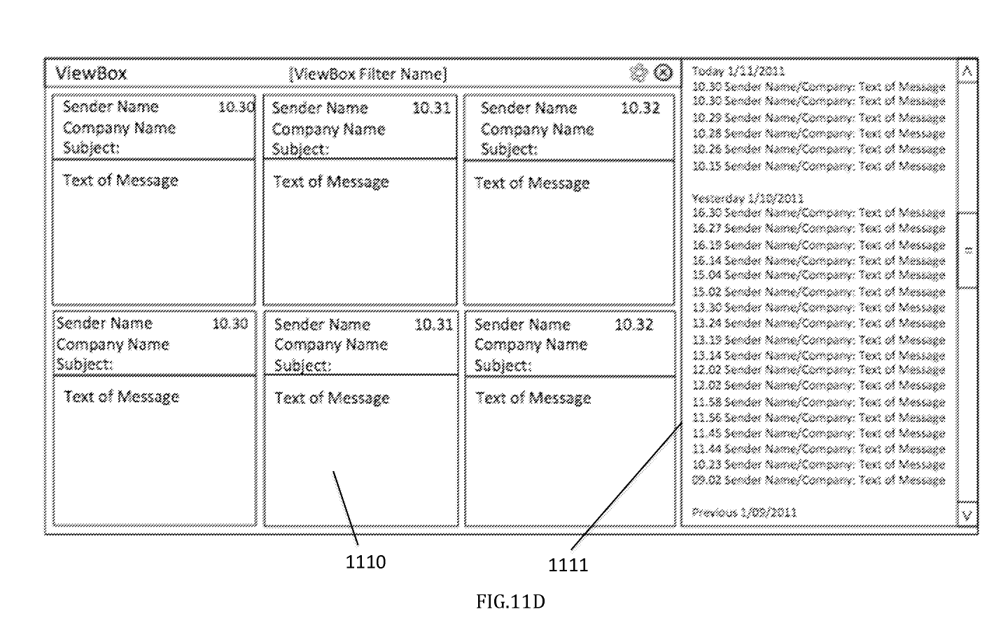

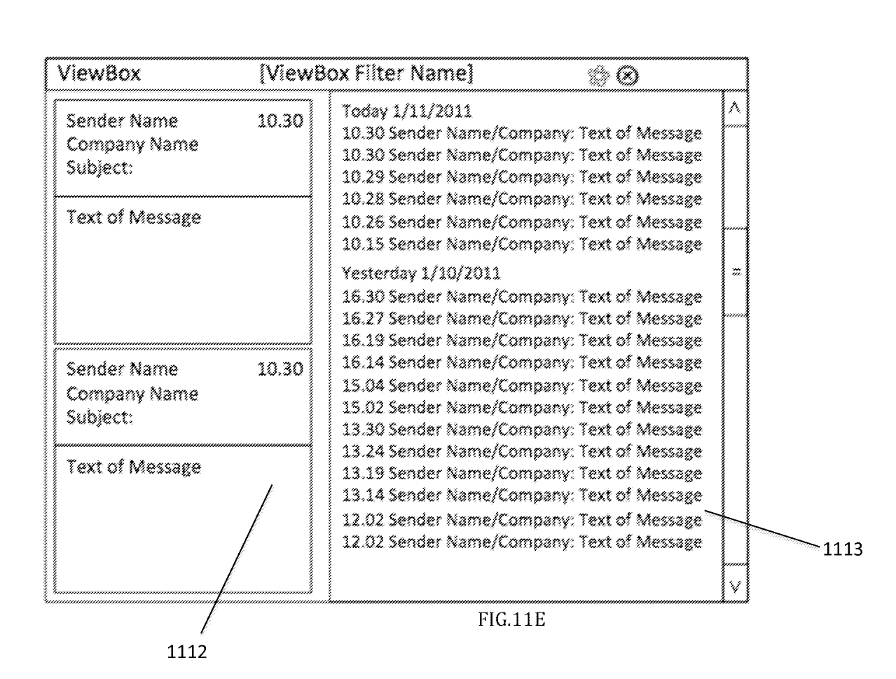

With the method and apparatus of the present invention, a content recipient (user) may define the type of information to be received, when this information is to be delivered and where such information should be delivered. In addition, the present invention provides a content provider with the ability to provide pricing information (and other content) to targeted consumers without risk of that information being delivered to unintended audiences. Content may be streamed to consumers (users) in real time. Consumers are presented with functionality that allows them to search for feeds of content which matches their interests (see FIG. 4 and the related discussion herein), and subscribe to a feed from a page which describes the content available (see FIG. 5 and the related discussion herein). Consumers can also be proactively subscribed to a feed by the provider of that feed. The functionality presented by the preferred embodiment of the present invention allows consumers to unsubscribe from any feed whenever required. These subscriptions can be managed by consumers using dedicated functionality which allows the user to unsubscribe and also to specify how the content is to be presented (FIG. 11A, 11B and 11C)

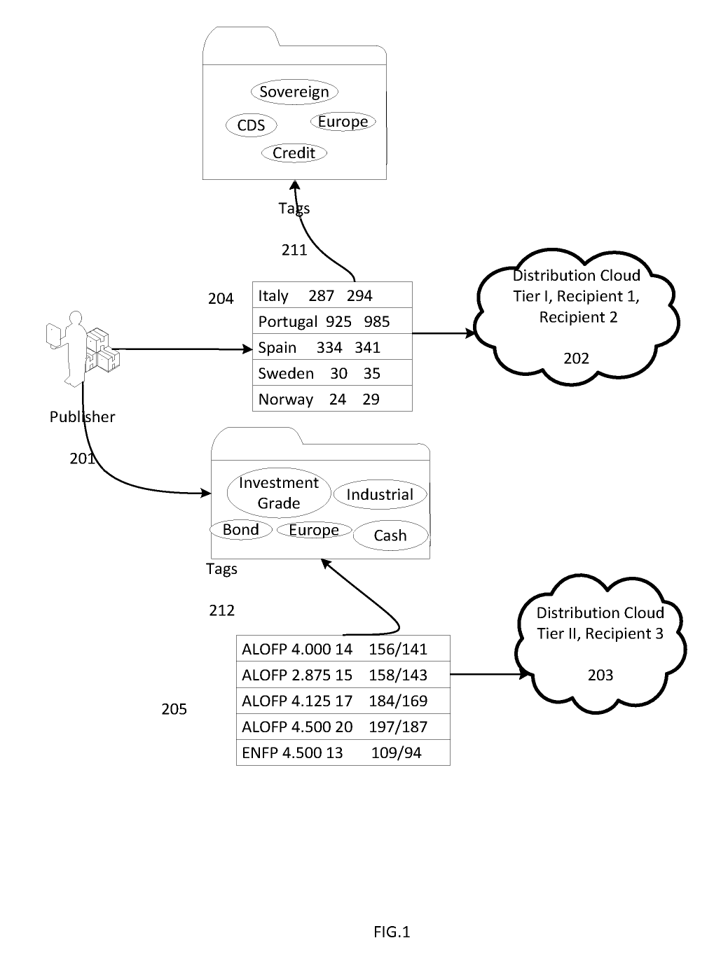

FIG. 1 block diagram that shows an example of one scenario of a content provider publishing content to users. Publisher 201 has a list of securities 204 (e.g., sovereign European credit default swaps) that the publisher wishes to make available for sale to certain client groups. Publisher 201 creates a short portfolio basket of these securities and provides tags 211 to the basket with names that identify the portfolio basket, e.g., tags such as CDS (Credit Default Swap), Sovereign, and Europe, that make it easier for the clients to find the particular basket. Finally, publisher 201 elects which of his clients will receive this portfolio basket, here the Tier I distribution list as well as two particular clients—Recipient 1 and Recipient 2 (target clients shown as ref. no. 202). FIG. 1 also shows a second distribution of content in the form of investment grade corporate bonds 205 which are provided with a second group of tags 212 and provided to a separate group of target clients 203 via a different distribution list consisting of the Tier II distribution list and a particular client identified as Recipient 3.

In summary, according to an embodiment the present invention a publisher 201 publishes content by way of three separate steps: (1) creating a portfolio basket (i.e., a list of securities or other financial products to be offered for sale); (2) provide a list of tags to the portfolio basket; and (3) select the particular clients that will receive the content (here the tagged portfolio basket) by creating a distribution list associated with this content. The present invention then automatically selects the correct feed to place this content on based on tags and the distribution list associated with the basket. In this summary, the portfolio basket is the customized information that is distributed. The present invention provides a mechanism for providing any type of information to the recipients identified on the distribution list. For the purposes of this invention, “customized information” is broadly defined to mean any type of information of any sort that is selected for distribution.

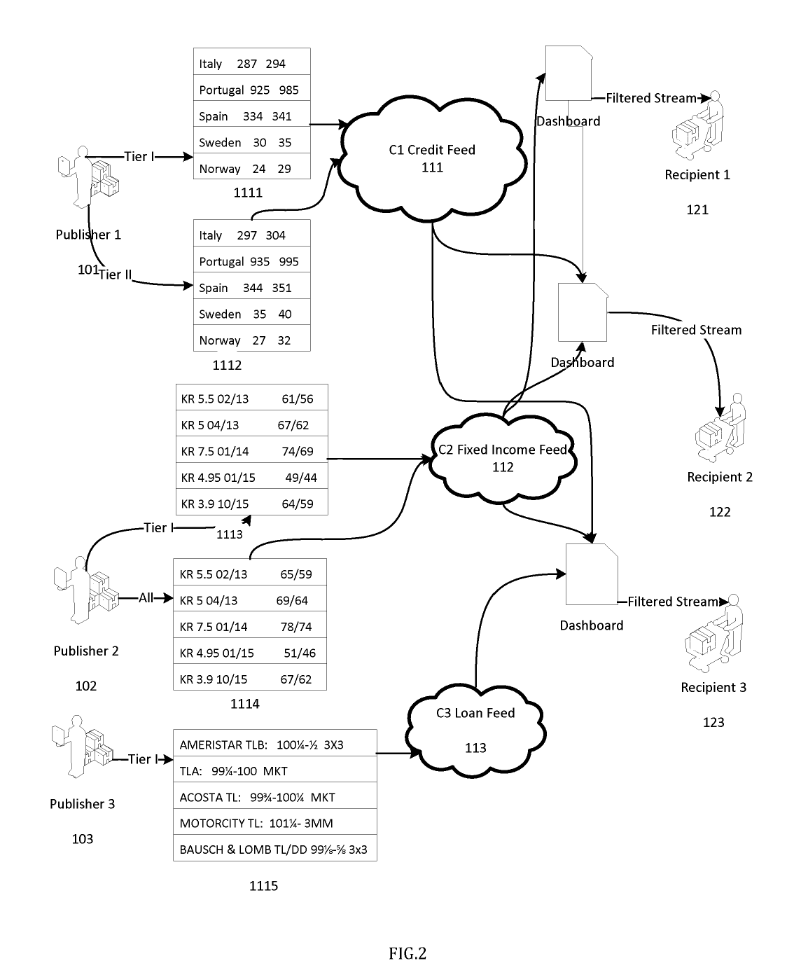

FIG. 2 is a block diagram that provides a further description of the workflow details of the preferred embodiment of the present invention. FIG. 2 shows a publisher (i.e., Publisher 1 101) selling a portfolio basket of European credit default swaps 1111, 1112. In this case—publisher 1 101 is able to publish the same basket of securities with different pricing for each set of customers (or other recipients of such information). For instance, the Tier I distribution list gets credit default protection on Italy for 287/294 basis points, i.e., portfolio 1111, while the Tier II distribution list that gets the same credit default protection on Italy for a higher rate of 297/304 basis points, i.e., portfolio 1112 which is at a more expensive rate than portfolio 1111. The present invention provide a way to publish these portfolios 1111, 1112 on the C1 Credit Feed based on the tags and distribution lists associated with the respective portfolios.

From a receiving perspective—Recipient 3 123 in FIG. 2 does not belong to either the Tier I distribution list or the Tier II distribution list—so when Recipient 3 123 subscribes to the C1 Credit Feed he does not get to see either portfolio 1111 or 1112. But when Recipient 2 122 looks at C1 Credit Feed—he sees only sees the second portfolio basket with Italy for 297/304, i.e., portfolio 1112. Note that the first and second portfolio baskets are identical except for the rates that they're being offered at. Recipient 1 121 gets to see only the discounted levels when he looks at C1 Credit Feed. On the same note—Recipient 2 also gets to see discounted levels on investment grade securities, i.e., portfolio 1113 from C2 Financial Fixed Income Feed. Recipient 1 121 sees KR 5.5 02/13 being offered at 61/56 (portfolio 1113) whereas Recipient 2 sees the same KR 5.5 02/13 security selling at 65/59 (portfolio 1114). The present invention allows a user to provide different based on who is looking at a particular product. Loyal customers, or customers with a better credit rating, get a discounted rate on products, while new or intermittent customers, or those with a lower credit rating, are offered products at the normal, non-discounted, rate.

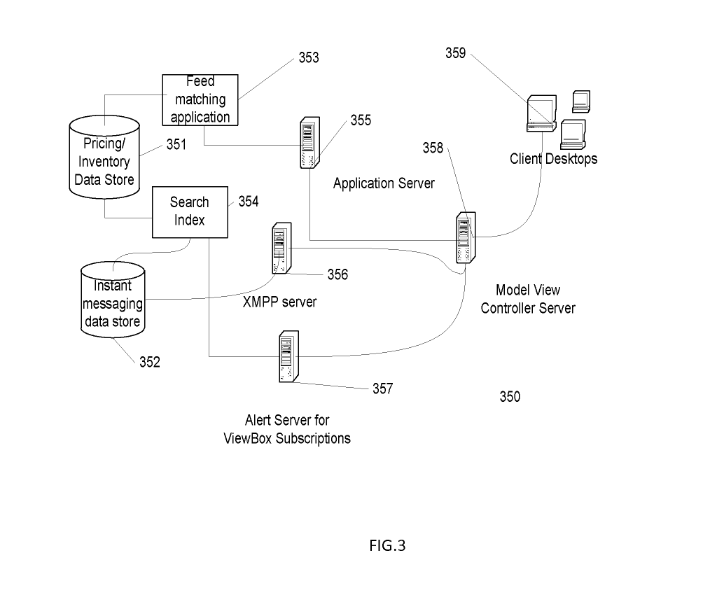

FIG. 3 is a block diagram of the system architecture 350 of the preferred embodiment of the present invention. System architecture 350 comprises a pricing inventory data store 351, an instant messaging data store 352, a feed matching application 353, a search index 354, an application server 355, an XMPP server 356, an alert server 357, a model view control server 358 and client desktop computers 359. The Pricing Inventory Data Store 351 is a system storage for all pricing information transmitted over the network as well as historical pricing for historical analysis of data, which is preferably stored in the form of relational records. The Instant Messaging Data Store 352 is a system for storage of all instant messaging conversations enabling users to communicate with each other. The Search Index 354 facilitates quick retrieval of data from the data store. The Application Server 355 is a system which provides all the business logic and provides back-end services for screen interactions. The application server is responsible for fetching data from the search index, the instant messaging data store and the pricing inventory data store. The XMPP Server 356 handles all XMPP communications between the client, application server and the instant messaging data store and also provides support for XEP (XMPP extension protocol). The Alert Server 357 is responsible for displaying alerts on the client desktop. Alert server 357 receives alert updates from the app server 355 and passes them on to UI widgets on the client desktops 359. The Model View Controller Server 358 abstracts all screen interaction logic from the application server logic and data access logic so it is easier to facilitate upgrades to separate parts of the system at a future date. The Client Desktop Computers 359 represent the desktop computer present at the client site(s) that are used to render the application.

Search index layer 354 is provided on top of the data stores 351, 352 in order to provide quick access to data. The feed matching application 353 determines what content gets delivered from which providers to which subscribers and applies privileging information to the content. The application server 355 takes care of all business logic and feeds the output to the model view controller server 358. An additional alert server 357 is also part of the system to push out real-time alerts to subscribers via the viewbox interface on the client desktops 359, as discussed below.

FIG. 4 shows a typical top-level user navigation screen 400 provided to content recipients (users). Users are able to search for and request a subscription to content feeds (desk feeds or simply feeds) via a keyword search box 401 on navigation screen 400. Users of the system of the present invention are able to navigate by typing a keyword into the search box 401 and selecting from matching results, which may include matching people 402, desks 403 to whom messages can be sent, keyword matches broken down by content 404, desk 405 or people 406 from whom messages have been received. Users are also able to see matching feeds 407 which are not currently subscribed but which are available for subscription. Each user of the system is assigned a unique identifier which is used for identification. To the end users of the system, they are able to find contacts and customers (recipients) through their name, firm names, location, etc. Users are able to create profiles for themselves, their feeds and their firms.

Feeds are maintained by the providers of content who use it for marketing purposes. When a potential consumer is interested in the content, the potential customer requests a subscription. If approved, content published to consumers will become available in this new customer's incoming feed. A customer may unsubscribe at any time. Each feed represents content of a particular nature including but not limited to financial instruments/asset types (e.g., corporate bonds, foreign exchange). Users/customers (recipients) are able to search by instrument, asset type, by attributes of that asset class or a combination of these and other elements by searching via a keyword or keywords in the search field above and viewing results 407 detailed in screen 400 or they can click on the options button 408 where one option will be to search for content. Upon finding a feed of interest, users may request a subscription, which request is then sent to the content provider for approval. Feed recommendations are made to end users based on current feed subscriptions, readership and usage patterns.

Some feeds may consist of an open broadcast of information which allow the content providers to advertise content to the consumers. The content providers have assigned administrators for each feed who receive all incoming subscription requests and approve/deny access for clients (consumers) and potential clients accordingly.

As discussed above, based on the entered search terms, users are also able to see matching but currently unsubscribed feeds. Upon selecting an unsubscribed feed, the user is presented with an information screen 500 shown in FIG. 5. The screen is essentially a marketing page 500 providing information 501 about the name of the content provider and the feed name, a description 502 of the feed, tags 503 which describe the content which will be delivered as part of the feed, an indicator 504 of the region from which the content is provided, administrator details 505 including, for example, the names and contact details of the content administrator(s), an identification 506 of the names of those that post content into the feed, and a button 507 which sends a subscription request to the content administrator(s).

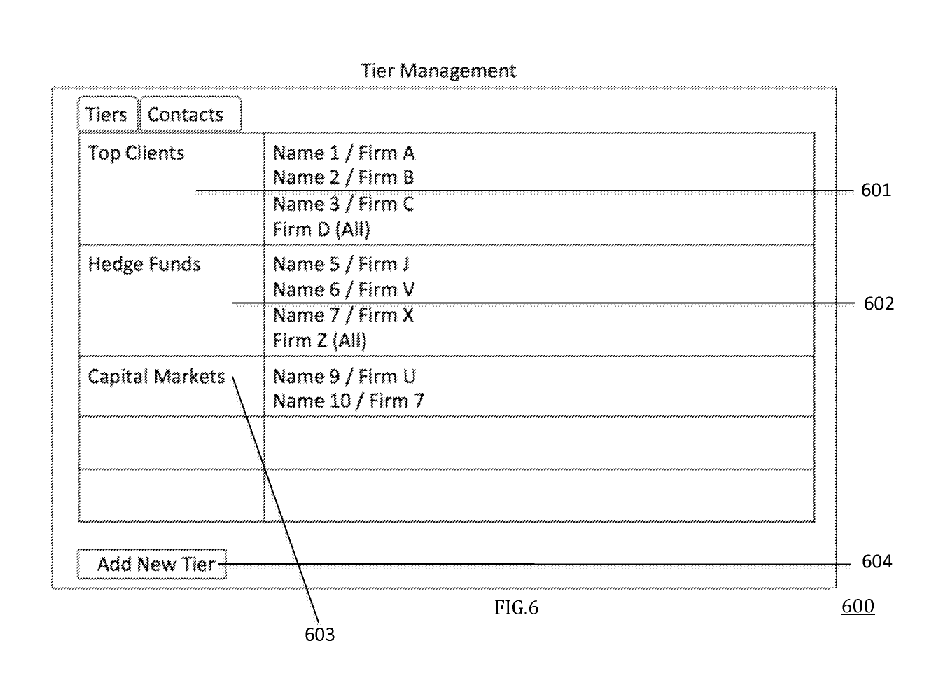

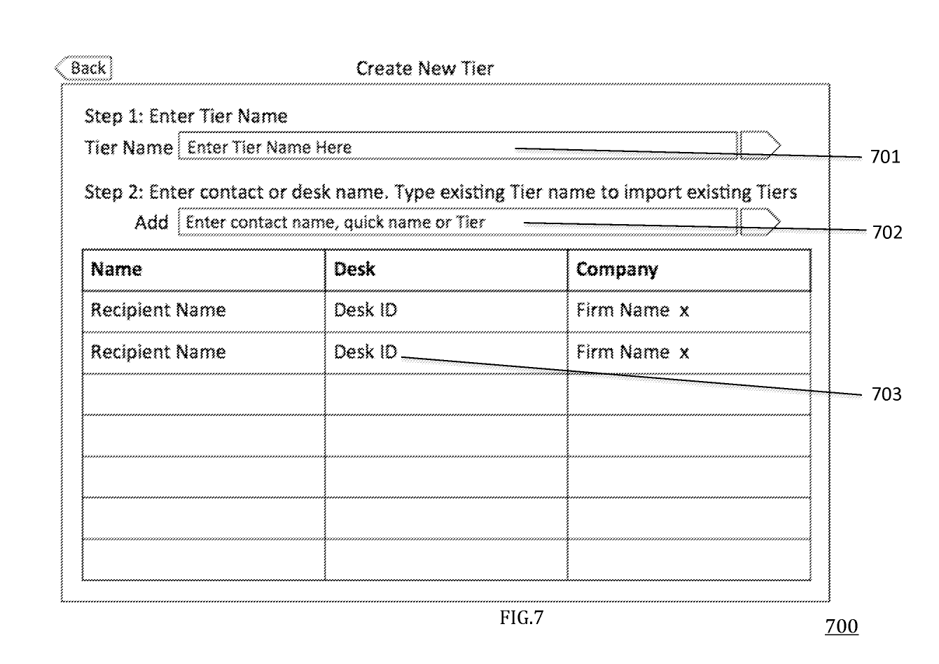

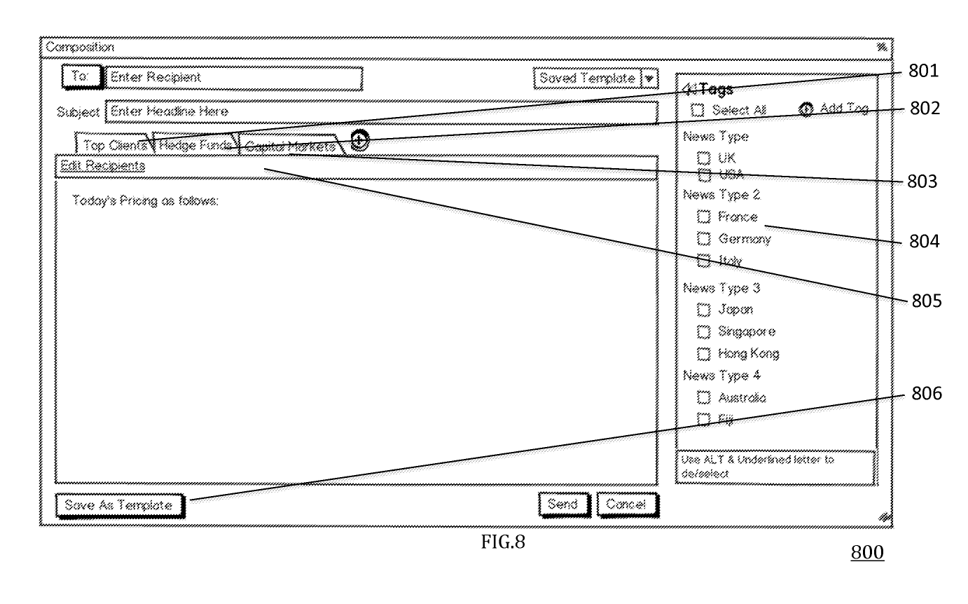

Providers of content are also able to manage how their content is distributed in the preferred embodiment of the present invention. The provider interface 600 is shown in FIG. 6, and includes a custom defined list of contacts and tiers. Tiers are groupings of contacts based on their status which are generated by the content provider based upon rankings. Three tiers are shown in FIG. 6, including Top Clients 601, Hedge Funds 602 and Capital Markets 603. The Add New Tier button 604 allows content providers to add new tiers via the input page 700 shown in FIG. 7. To create a new tier, a provider first enters a name for the tier in box 701 and then enters a series of contacts or desk names in box 702. Each added contact or desk name will appear in the list 703. Publishers of content can also proactively subscribe a consumer to a feed. In this case, the subscribed users are alerted and, depending on their preference settings, the subscription is automatically added or brought to the attention of the user via a predetermined type of notification.

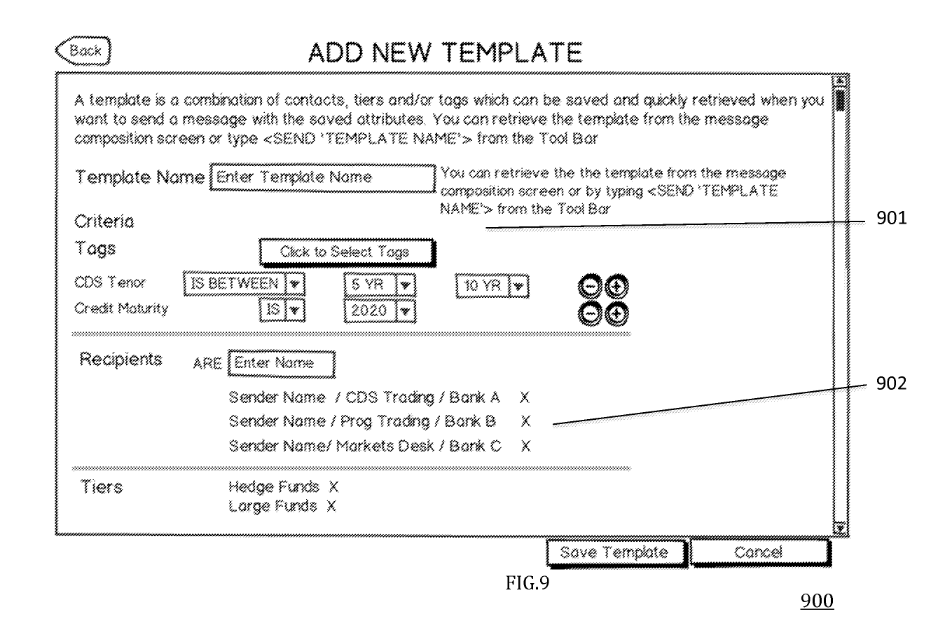

FIG. 8 shows a presently preferred version of the content composition screen 800. In FIG. 8, the content provider is publishing to three tiers, identified as Top Clients, Hedge Funds and Capital Markets, each selected the associated respective tabs 801, 802, 803. A collection of tags available which may be used for filtering by recipients are listed in the right hand side box 804. The content provider enters the information to be published in field 805. Templates consisting of pre-defined mixes of tiers and tags can be saved for easy retrieval for sending later content based on the same pre-defined mix. Button 806 provides a direct save link from the composition screen 800. The advantage of having content organized into categorized templates means that the extraction of that data can be used to feed analytics or as a simple aggregated pricing feed. As the data is categorized before it is published, it is more accurate than any other pricing extraction service.

FIG. 9 shows a dedicated advanced set-up window 900 for creating composition templates which allows the content provider to pre-define criteria 901 and recipients 902 into a template that is used by the content provider to more easily and quickly enter and publish information to the target content recipients.

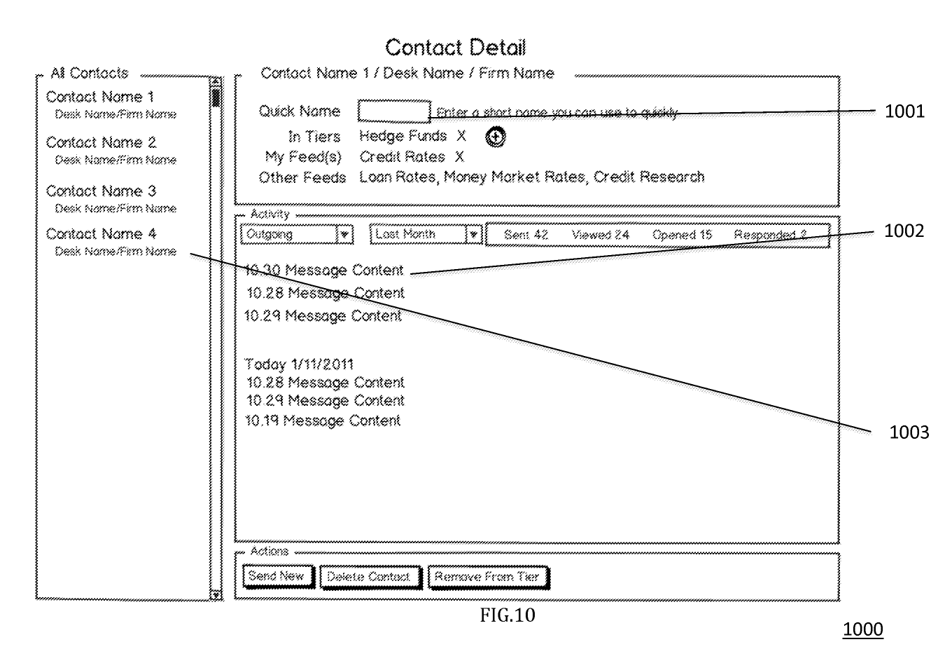

FIG. 10 shows a contact detail page 1000 which allows users to create a list of preferred contacts to whom they can assign Quick Names 1001 which allows them to quickly reference the name without typing the whole name. Contact detail screen 1000 also allows users to view aggregate activity statistics for the specified contact for a given period of time 1002. Such activity statistics may include, for example, messages sent, messages received, messages viewed, messages read and/or messages responded to.

FIGS. 11A and 11B shows the ViewBox settings page 1100, 1101. Recipients (users) use the view box setting page to create content filters based on the attributes and characteristics tagged by the content providers to generate a ViewBox 1102 as shown in FIG. 11C. FIG. 11A shows screen 1101 which a user uses to select from a variety of criteria used to create a filter, including but not limited to the Feed Name 1103, type of content 1104, tags 1105 that have been assigned by content publisher to published content, and sender names 1106. FIG. 11B shows screen 1101 used to customize the display of the content by defining parameters including but not limited to whether the headline view is displayed, the number and layout of the preview grid (using, for example, boxes 1107), the speed with which incoming messages are displayed, and whether the headline view is not displayed. FIG. 11C shows an example ViewBox configured with three preview boxes 1108 listed horizontally and a list of associated headlines 11095. The configurable ViewBox provides users with the ability to preview content at a selected speed and enables them to more easily consume and digest streaming content in a way that e-mail and instant messaging does not allow—especially when the received content consists of pricing or other informational data, as opposed to conversational communication.

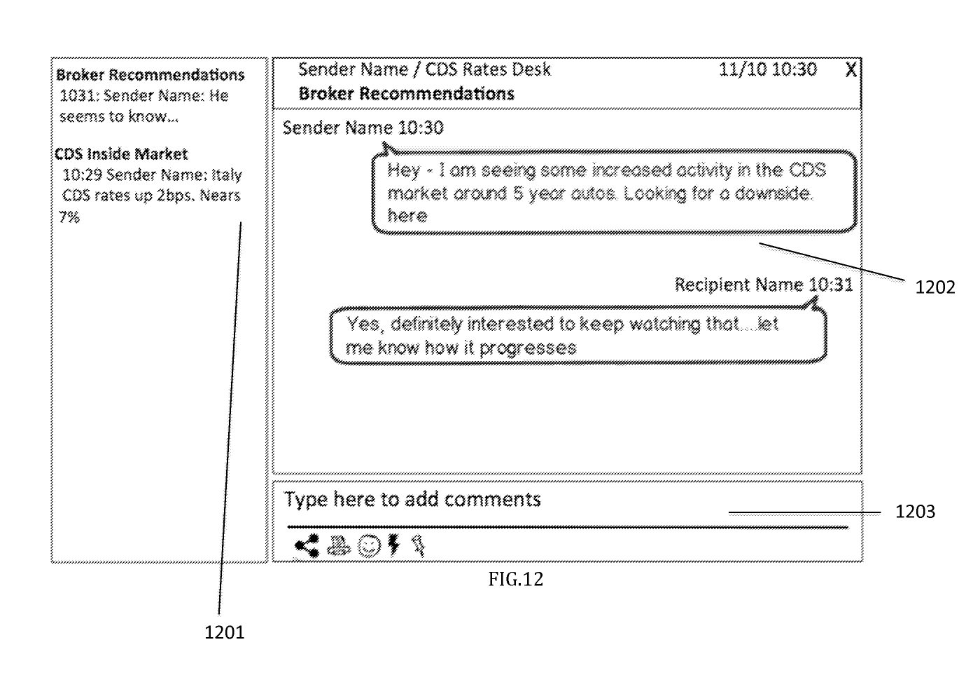

Users use the response box 1200 shown in FIG. 12 to read an entire message and/or to respond to a message by selecting the message in the ViewBox 1103. The response box 1200 is a hybrid between an instant message interface and an email interface because it allows recipients to easily manage their conversations with content providers. Opened conversations are listed on the left hand side 1201 of the response box 1200 while the active conversation in focus is listed on the right hand side 1202 of the response box 1200. A response to a content provider communication is generated using the input field 1203 shown at the bottom of the response screen 1200. For conversational communication, the present invention integrates with conventional instant messaging services including for example AOL IM, MSN IM and Google Chat (GChat).

In order to manage the large amounts of content which consumers are entitled to view, a key element of the present invention is the ability to create filters to display content in a user defined manner in the ViewBox 1102. In particular, a user may filter the data by attributes/characteristics of thereof and display it in a manner that best befits the workflow of that user. For example, a consumer may have five subscription feeds for CDS pricing, but may choose to create two views for the incoming CDS pricing based on currency (e.g., EUR and USD denominated instruments). Additionally, a consumer can create filters of attributes or characteristics which ‘listen’ for content being offered that matches the set criteria. An example would be a money manager who is interested in new corporate bond issues with a coupon between 1% and 4%, 5 year maturity in the banking sector with an investment grade credit rating. The consumer can create a filter using the present invention which displays matching securities offered by content providers that are available from both content providers that have authorized them and from other content providers who are advertising such bonds via open feeds.

Using the present invention, content providers may publish content on predefined feeds. These feeds will often be defined around groups of individuals (e.g., desks) that provide specific pricing and other related services to their customers. Content published into feeds may have characteristic tags that are manually or automatically assigned to such content. These tags represent various characteristics on which recipients may filter (as detailed above).

An important differentiating feature of the present invention is the ability to publish different prices to subscribers of the same feed. The difference in content including, but not limited to, pricing is determined by the tiers that are set by publishers of content. For example, a content provider publishes to a CDS price feed, but the prices differ based on the different tiers which reflect how aggressive the broadcaster wishes to be about pricing. Providers determine which tier a recipient falls into based on various characteristics, including but not limited to credit profile, standing with the company, size of company or other rationale based on the relationship between the two parties. For example, a content provider may have a feed for CDS pricing with three tiers, one for internal distribution (e.g., from traders to sales people), one for valued customers who demand very competitive pricing and another for everyone else.

In order to ensure that publishers are catering to the needs of their customers, content publishers using the present invention are able to aggregate usage, subscription and readership data. For example, an individual publisher is able to see for an individual consumer, feed or tier perspective how many users are reading content distributed to them and how many individuals have subscribed or unsubscribed to a feed. This data can also be aggregated on a more macro basis which allows evaluation on a desk, department or firm wide basis.

Content providers as well as consumers have access to full contact management functionality that allows them to manage (add/remove) their contacts, create tiers, export and share contacts and outsource the administration of all of the above to other users or administrators. The intention is to allow integration with CRM systems and other systems which aggregate trading activity. Specific analytics are built to reconcile trading activity to content received, read etc. on both an individual recipient, firm and tier basis.

While the present invention has been particularly shown and described with reference to the preferred embodiments and various aspects thereof, it will be appreciated by those of ordinary skill in the art that various changes and modifications may be made without departing from the spirit and scope of the invention. It is intended that the appended claims be interpreted as including the embodiments described herein, the alternatives mentioned above, and all equivalents thereto.

What is claimed is:

1. A computer-implemented method for providing customized information from a content provider to a plurality of recipients, comprising the steps of:
ranking, in a first computer server, a selected portion of the recipients into at least two separate tiers of recipients based upon a predetermined criteria;
generating, at the first computer server and via a content provider interface, customized information for transmission to the recipients;
generating, at the first computer server and via the content provider interface, associated information related to the customized information for each separate tier; and
transmitting the customized information and the respective associated information to each tier of recipients.

2. The computer-implemented method of claim 1, wherein the customized information comprises information identifying particular financial instruments offered for sale.

3. The computer-implemented method of claim 2, wherein the associated information comprises pricing information for the particular financial instruments offered for sale.

4. The computer-implemented method of claim 1, wherein the predetermined criteria comprises a rating based upon past purchases by each customer.

5. The computer-implemented method of claim 1, wherein the predetermined criteria comprises a credit rating of each customer.

6. The computer-implemented method of claim 1 wherein each customer provides information prior to receiving any customized information and wherein the ranking step is also based upon the information provided by each customer.

7. The computer-implemented method of claim 1, further comprising the steps of:
identifying one or more particular recipients not included with any of the tiers of recipients to be associated with a respective one of the tiers of recipients; and
for each identified one or more particular recipients, transmitting the customized information and the respective associated information for the associated one of the tiers of recipients to the identified one or more particular recipients.

8. A computer-implemented method for providing customized information from a plurality of content providers to a plurality of recipients, wherein each of the plurality of content providers performs the steps of:
ranking, in a first computer server, a selected portion of the recipients into at least two separate tiers of recipients based upon a predetermined criteria;
generating, at the first computer server and via a content provider interface, customized information for transmission to the recipients;
generating, at the first computer server and via the content provider interface, associated information related to the customized information for each separate tier; and
transmitting the customized information and the respective associated information to each tier of recipients.

9. The computer-implemented method of claim 8, wherein the customized information comprises information identifying particular financial instruments offered for sale.

10. The computer-implemented method of claim 9, wherein the associated information comprises pricing information for the particular financial instruments offered for sale.

11. A system for providing customized information from a content provider to a plurality of recipients, comprising:
a first computer server having a content provider interface for ranking a selected portion of the recipients into at least two separate tiers of recipients based upon a predetermined criteria, the content provider interface also for generating customized information for transmission to the recipients, and the content provider interface also for generating associated information related to the customized information for each separate tier; and
a second computer server in communication with the first computer server for transmitting the customized information and the respective associated information to each tier of recipients.

12. The system of claim 11, wherein the customized information comprises information identifying particular financial instruments offered for sale.

13. The system of claim 12, wherein the associated information comprises pricing information for the particular financial instruments offered for sale.

14. The system of claim 11, wherein the predetermined criteria comprises a rating based upon past purchases by each customer.

15. The system of claim 11, wherein the predetermined criteria comprises a credit rating of each customer.

16. The system of claim 11 wherein each customer provides information prior to receiving any customized information and wherein the ranking step is also based upon the information provided by each customer.

17. The system of claim 11, wherein the first server also identifies one or more particular recipients not included with any of the tiers of recipients to be associated with a respective one of the tiers of recipients, and wherein the second computer server also, for each identified one or more particular recipients, transmits the customized information and the respective associated information for the associated one of the tiers of recipients to the identified one or more particular recipients.

18. The system of claim 11, wherein the first server includes a plurality of separate content provider interfaces, each associated with an associated one of a plurality of content providers, for providing customized information from a plurality of content providers to a plurality of recipients.

19. A computer-implemented method for providing customized information from a content provider to a plurality of recipients, comprising the steps of:
ranking, in a first computer server, a selected portion of the recipients into at least two separate tiers of recipients based upon a predetermined criteria;
generating, at the first computer server and via a content provider interface, customized information for transmission to the recipients;
generating, at the first computer server and via the content provider interface, associated information related to the customized information for each separate tier;
generating, at the computer server and via the content provider interface, a tag list of at least one recipient to receive the customized information and associated information for at least one of the separate tiers; and
transmitting the customized information and the respective associated information to each tier of recipients and to each recipient on the tag list.

20. A computer-implemented method for providing customized information from a content provider to a plurality of recipients, comprising the steps of:
generating, at the first computer server and via a content provider interface, customized information for transmission to the recipients;
generating, at the first computer server and via the content provider interface, a first set of associated information related to the customized information;
generating, at the first computer server and via the content provider interface, a second set of associated information related to the customized information;
generating, at the computer server and via the content provider interface, a first tag list of at least one recipient to receive the customized information and first set of associated information;
generating, at the computer server and via the content provider interface, a second tag list of at least one recipient to receive the customized information and second set of associated information; and
transmitting the customized information and the respective associated information to each recipient on the first and second tag lists.

21. A system for providing customized information from a content provider to a plurality of recipients, comprising:
a first computer server having a content provider interface for ranking a selected portion of the recipients into at least two separate tiers of recipients based upon a predetermined criteria, the content provider interface also for generating customized information for transmission to the recipients, the content provider interface also for generating associated information related to the customized information for each separate tier, the content provider interface also for generating a tag list of at least one recipient to receive the customized information and associated information for at least one of the separate tiers; and
a second computer server for transmitting the customized information and the respective associated information to each tier of recipients and to each recipient on the tag list.

22. A system for providing customized information from a content provider to a plurality of recipients, comprising:
a first computer server having a content provider interface for generating customized information for transmission to the recipients, the content provider interface also for generating a first set of associated information related to the customized information, the content provider interface also for generating a second set of associated information related to the customized information, the content provider interface also for generating a first tag list of at least one recipient to receive the customized information and first set of associated information, the content provider interface also for generating a second tag list of at least one recipient to receive the customized information and second set of associated information; and
a second computer server for transmitting the customized information and the respective associated information to each recipient on the first and second tag lists.
